(19) United States
(12) Patent Application Publication
(10) Pub. No.: US 2017/0343132 A1
(43) Pub. Date: Nov. 30, 2017

(54) PIPELINE SKID AND SKID SUPPORT SYSTEM

(71) Applicants: Cody Stanley Stacey, Coldstream (CA); Cody Brian James Stewart, Morinville (CA)

(72) Inventors: Cody Stanley Stacey, Coldstream (CA); Cody Brian James Stewart, Morinville (CA)

(21) Appl. No.: 15/164,011

(22) Filed: May 25, 2016

(51) Int. Cl. F16L 3/00

(52) U.S. Cl. CPC F16L 3/00

(57) ABSTRACT

A pipeline support, comprising: at least one skid-block, comprising a rectangular-shaped solid or hollow surface comprising a top surface; a bottom surface; a left side surface and a right side surface; and a front side surface and a back side surface, wherein the bottom surface comprises a plurality of receiving notches that are capable of interlocking with a width of the top surface of a vertically adjacent skid-block, and wherein the pipe support is capable of supporting a portion of a pipe in a stable position at a desired elevation on a portion of the top surface.

### FIELD OF THE INVENTION

The present disclosure is in the field of pipeline skid support blocks and pipeline skid support structures.

### BACKGROUND OF THE DISCLOSURE

Pipeline supports typically have been formed by lengths of a plurality of wooden skids arranged under the pipeline so as to support the pipe in a desired elevated position. The wooden pipeline supports provide limited lateral support for the elevated pipeline and can be labor extensive when forming the several wooden blocks into a suitable stacked arrangement to provide pipeline support in a desired orientation. To increase the elevation of the overall support structure, multiple wooden blocks typically must be arranged together in a pile and the resulting structure has limited stability. Moreover, wooden pipeline supports inherently cause damage to the pipeline coating as the pipeline is manipulated and with contraction and expansion of the pipeline during temperature fluctuations. Damaged pipeline coatings result in additional expenses to repair the damaged coating resulting in excessive expenses in manpower, time and equipment. Also, wooden pipeline supports are heavy and bulky and prone to breaking into pieces particularly when the wooden pipeline supports get wet. During winter months the wooden pipeline supports can become buried in snow and ice and the user may not be able to locate the wooden skid blocks.

Therefore, there is need for a strong lightweight skid-block that can be arranged in a variety of skid-block piles and does not damage pipeline coatings and can be easily observed on the job site with the use of fluorescent orange or yellow markings.

### SUMMARY OF THE INVENTION

A pipeline support, comprising: at least one skid-block, comprising a rectangular-shaped solid or hollow surface comprising a top surface; a bottom surface; a left side surface and a right side surface; and a front side surface and a back side surface, wherein the bottom surface comprises a plurality of receiving notches that are capable of interlocking with a width of the top surface of a vertically adjacent skid-block, and wherein the pipe support is capable of supporting a portion of a pipe in a stable position at a desired elevation on a portion of the top surface.

### BRIEF DESCRIPTION OF THE DRAWINGS

FIG. 1 is an illustration of a skid-block 100 of the disclosure herein comprising receiving notches 108, 110, and 112.

FIG. 2 is an illustration of a skid-block 200 of the disclosure herein comprising receiving notches 208, 210, 212, and 216.

FIG. 3 is an illustration of a ground crotch support pile 300 comprised of a plurality of skid-blocks 100.

FIG. 4 is an illustration of a slider support pile 400 comprised of a plurality of skid-blocks 100.

FIG. 5 is an illustration of a box crotch support pile 500 comprised of a plurality of skid-blocks 200.

FIG. 6 is an illustration of a box support pile 600 comprised of a plurality of skid-blocks 100.

### DETAILED DESCRIPTION OF THE EMBODIMENTS

The following is a detailed description of certain specific embodiments of the skid-blocks and corresponding pipeline supports disclosed herein. In this description reference is made to the drawings.

In one aspect, disclosed herein is a pipeline support, comprising: at least one skid-block, comprising a rectangular-shaped solid or hollow surface comprising a top surface; a bottom surface; a left side surface and a right side surface; and a front side surface and a back side surface, wherein the bottom surface comprises a plurality of receiving notches that are capable of interlocking with a width of the top surface of a vertically adjacent skid-block, wherein the pipe support is capable of supporting a portion of a pipe in a stable position at a desired elevation on a portion of the top surface, and wherein the at least one skid-block is comprised of rubber, metal, plastic or a combination thereof.

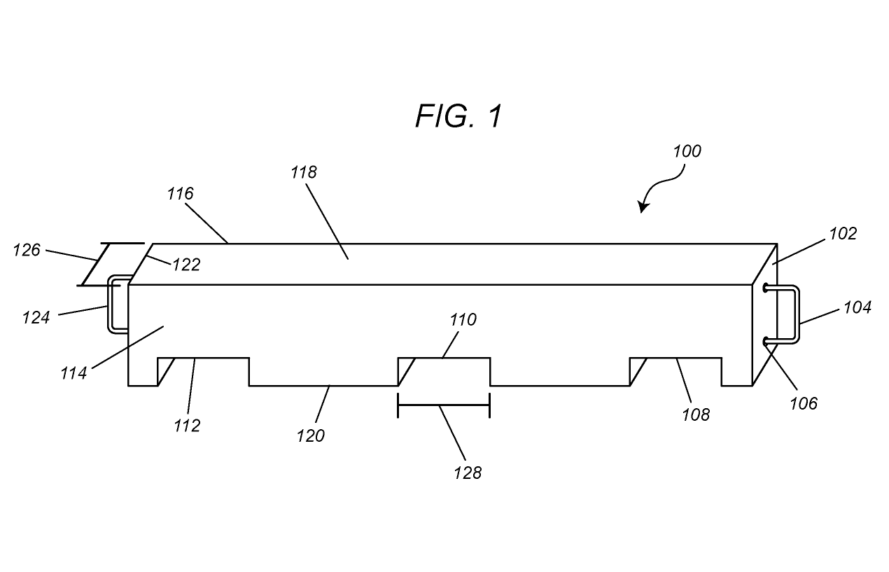

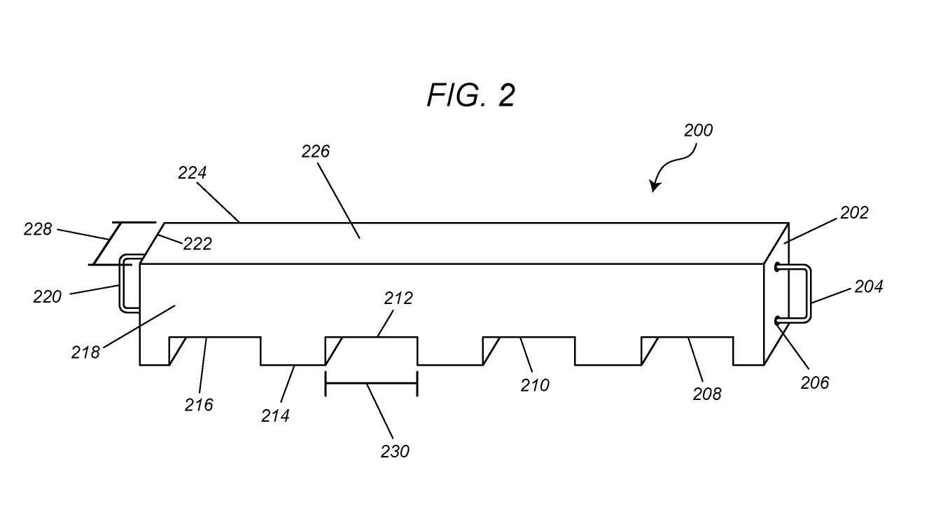

Turning to the drawings, FIGS. 1 and 2 are illustrations of skid-blocks 100 and 200 of the disclosure herein comprising receiving notches 108, 110, and 112 and receiving notches 208, 210, 212, and 216, respectively. The pipeline skid-blocks 100 and 200 of the present disclosure may be of a single-piece construction and formed of a durable plastic material such as high density polyethylene (HDPE) or discarded rubber tires. In some embodiments, the skid-blocks are constructed from plastic derived from polyethylene, polyethylene (HDPE) and/or polypropylene. Additional examples may include low density polyethylene (LDPE), linear low density polyethylene (LLDPE), polypropylene, polybutylene and copolymers of ethylene such as polyethylene-vinyl acetate (EVA), polyethylene-acrylic acid (EAA), polyethylene-methacrylic acid EMA) or copolymers of ethylene or propylene with the lower olefins such as, butene-1, pentene-1, hexene or octane, or a combination thereof.

In some embodiments, the skid-blocks 100 and 200 of the disclosure herein are comprised of rubber and/or plastic coating or surface and is capable of reducing damage to a coating of a pipeline. In some embodiments, the top surface is comprised of rubber and/or plastic and is capable of reducing damage to a coating of a pipeline. In some embodiments, the skid-blocks 100 and 200 comprise fluorescent orange or fluorescent yellow markings for a means of identification on a job site. In some embodiments, the skid-blocks 100 and 200 comprise fluorescent orange or fluorescent yellow markings for a means of identification on a job site comprised of mud and snow.

The skid-block 100 defines a rectangular body portion comprising a top surface 118, a bottom surface 120, a left side surface 114, a right side surface 116, a front side surface 102, and a back side surface 122, wherein the bottom surface comprises a plurality of receiving notches 108, 110 and 112 that are capable of interlocking with a skid-block width 126 of the top surface of a vertically adjacent skid-block. The skid-block 100 has a generally flat top surface 118, left side surface 114, right side surface 116, front side surface 102, and back side surface 122. Moreover, the front side surface 102 and the back side surface 122 may comprise handles 104 and 124 which are affixed to the skid-block with fasteners 106, respectively. In some embodiments, the fasteners 106 are comprised of bolts, which are capable of affixing the handles to the skid-block. In this aspect, the user(s) with the strong lightweight design will be able to easily move and lift the skid-blocks via handles 104 and 124.

The skid-block 200 defines a rectangular body portion comprising a top surface 226, a bottom surface 214, a left side surface 218, a right side surface 224, a front side surface 202, and a back side surface 222, wherein the bottom surface comprises a plurality of receiving notches 208, 210, 212 and 216 that are capable of interlocking with a skid-block width 222 of the top surface of a vertically adjacent skid-block. The skid-block 200 has a generally flat top surface 226, left side surface 218, right side surface 224, front side surface 202, and back side surface 222. Moreover, the front side surface 202 and the back side surface 222 may comprise handles 204 and 220 which are affixed to the skid-block with fasteners 206, respectively. In some embodiments, the fasteners 206 are comprised of bolts, which are capable of affixing the handles to the skid-block. In this aspect, the strong lightweight design will allow users to be able to easily move and lift the skid-blocks via the handles.

The receiving notch widths 128 and 228 are capable of accommodating the skid-block widths 126 and 212, respectively. In some embodiments, the notch widths 128 and 228 are about 2% to 19% larger than the skid-block widths 126 and 212, respectively. In this aspect, the notch widths 128 and 228 may be slightly larger than the corresponding skid-block widths 126 and 212 to prevent dirt and debris accumulation within the notches or on the surface of the skid-block's top surface from impeding interlocking the adjacent skid-blocks. In some embodiments, the at least one skid-block comprises between about 2 to about 10 receiving notches. In some embodiments, the at least one skid-block comprises between about 3 to about 4 receiving notches. In some embodiments, the receiving notches are each comprised of a cavity that extends the width of the bottom surface and is capable of engaging with a vertically adjacent skid-block. In some embodiments, the receiving notches are each comprised of a square or rectangular cavity that extends the width of the bottom surface and is capable of engaging with a vertically adjacent skid-block. In some embodiments, the receiving notches are square or rectangular and are parallel and evenly spaced about a length of the bottom surface. In some embodiments, the skid-blocks disclosed herein comprise between about 2 to about 100 notches.

In some embodiments, the at least one skid-block has a thickness of between about 2 inches and 8 inches, a width of between about 2 inches and 12 inches and a length of between about 1 foot and 8 feet. In some embodiments, the at least one skid-block has a thickness of about 4 inches, a width of about 6 inches and a length of about 4 feet. In some embodiments, the at least one skid-block has a thickness of about 4 inches, a width of about 6 inches and a length of about 5 feet.

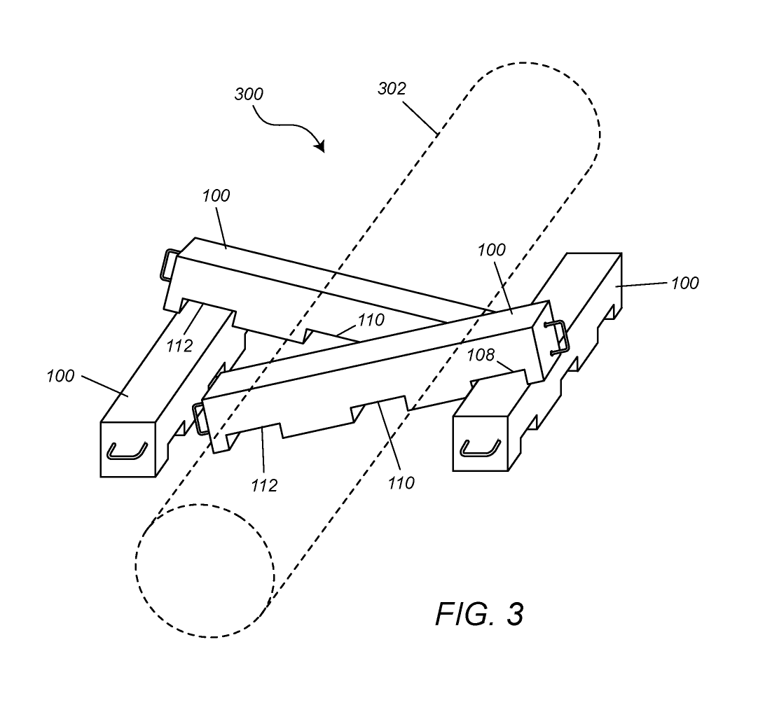

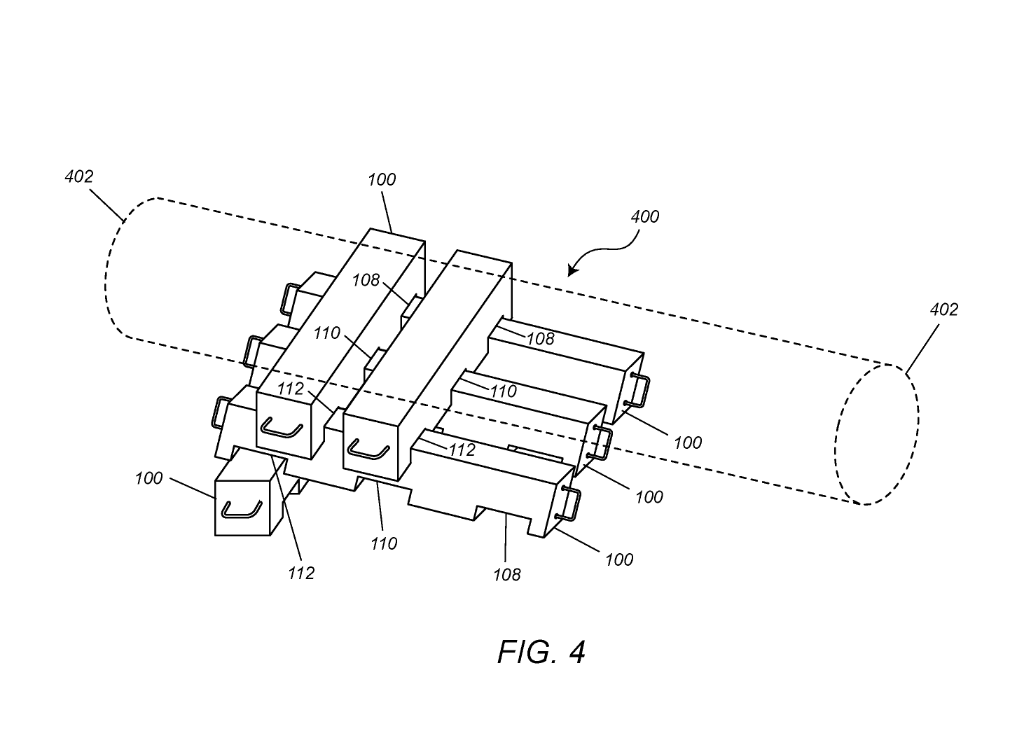

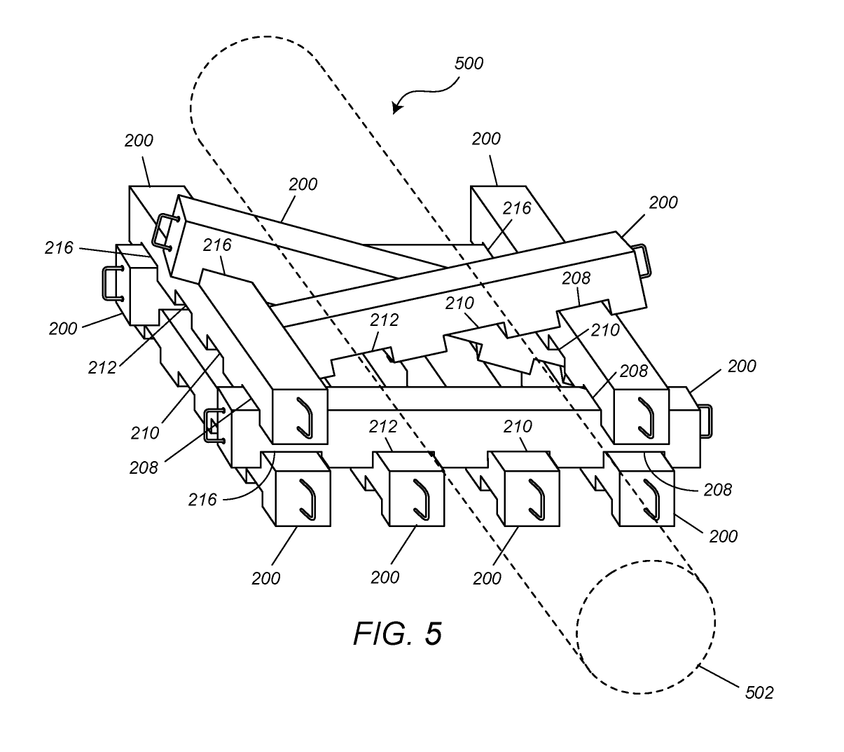

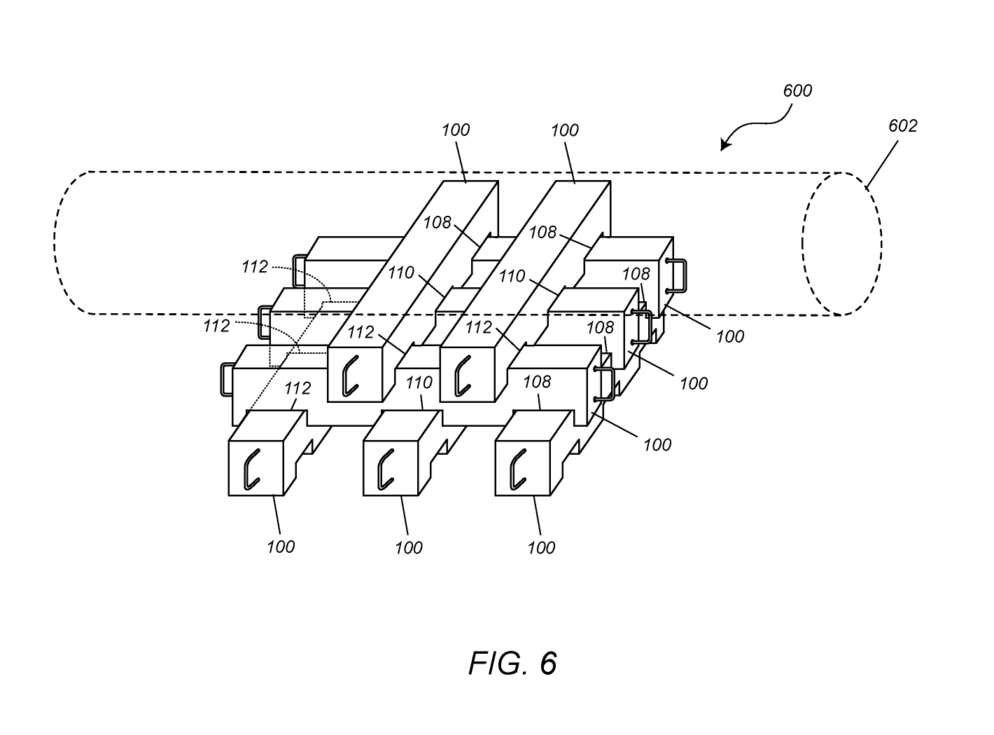

Turning to the drawings, FIG. 3 depicts a ground crotch support pile 300 comprised of a plurality of skid-blocks 100 as supporting a portion of pipeline 302 between the V-shape afforded by the top row of skid-blocks that are arranged at opposed angles. FIG. 4 represents a slider support pile 400 comprised of a plurality of skid-blocks 100 as supporting a portion of pipeline 402 whereby the top row of skid-blocks may be slide down the vertically adjacent interlocked skid-blocks to a lower elevation or higher elevation depending on the height of the pipeline that is required. FIG. 5 represents a box crotch support pile 500 comprised of a plurality of skid-blocks 200 as supporting a portion of pipeline 502 between the V-shape afforded by the top row of skid-blocks that are arranged at opposed angles employing skid-blocks 200. FIG. 6 is an illustration of a box support pile 600 comprised of a plurality of skid-blocks 100 whereby the top row of skid-blocks are supporting the pipeline 602 in an otherwise flat orientation relative to the ground. In this aspect, the support piles are arranged in a particular combination of interlocked skid-blocks depending on the angle of the ground and elevation needed. The support piles of the disclosure herein are examples and are not exhaustive, and an embodiment can include other types of support piles.

In some embodiments, the pipeline support further comprises at least one interlocked pair of skid-blocks, wherein the interlocked skid-blocks are perpendicular relative to each other so as to prevent relative rotation thereof and to form an interlocked stack of vertically adjacent skid-blocks. In some embodiments, the pipeline support further comprises at least one interlocked pair of skid-blocks, wherein the interlocked skid-blocks are perpendicular relative to each other so as to prevent relative rotation thereof and to form an interlocked stack of vertically and horizontally adjacent skid-blocks. In some embodiments, the pipeline support further comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a one or more rows of horizontally adjacent skid-blocks arranged at an angle relative to the corresponding vertically adjacent skid-blocks. In some embodiments, the pipeline support further comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a top row of horizontally adjacent skid-blocks arranged at an angle relative to the corresponding vertically adjacent skid-blocks. In some embodiments, the pipeline support further comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, wherein the square or rectangular stack comprises a top row of horizontally adjacent skid-blocks arranged at opposed angles relative to each corresponding horizontally adjacent skid-block.

In some embodiments, the pipe support comprises a plurality of skid-blocks arranged as a ground crotch support pile. In some embodiments, the pipe support comprises a plurality of skid-blocks arranged as a slider support pile. In some embodiments, the pipe support comprises a plurality of skid-blocks arranged in a box crotch support pile. In some embodiments, the pipe support comprises a plurality of skid-blocks arranged in a box support pile.

In another aspect, disclosed herein is a method of providing a pipeline support, comprising: a) providing a pipeline; and b) arranging a plurality of skid-blocks to support the pipeline, wherein each skid-block comprises a rectangular-shaped solid or hollow surface comprising a top surface; a bottom surface; a left side surface and a right side surface; and a front side surface and a back side surface, wherein the bottom surface comprises a plurality of receiving notches that are capable of interlocking with a width of the top surface of a vertically adjacent skid-block, and wherein the pipe support is capable of supporting a portion of a pipe in a stable position at a desired elevation on a portion of the top surface.

In some embodiments, the method of providing a pipeline support comprises at least one interlocked pair of skid-blocks, wherein the interlocked skid-blocks are perpendicular relative to each other so as to prevent relative rotation thereof and to form an interlocked stack of vertically adjacent skid-blocks. In some embodiments, the method of providing a pipeline support comprises at least one interlocked pair of skid-blocks, wherein the interlocked skid-blocks are perpendicular relative to each other so as to prevent relative rotation thereof and to form an interlocked stack of vertically and horizontally adjacent skid-blocks. In some embodiments, the method of providing a pipeline support comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a one or more rows of horizontally adjacent skid-blocks arranged at an angle relative to the corresponding vertically adjacent skid-blocks. In some embodiments, the method of providing a pipeline support comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a top row of horizontally adjacent skid-blocks arranged at an angle relative to the corresponding vertically adjacent skid-blocks. In some embodiments, the method of providing a pipeline support comprises a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, wherein the square or rectangular stack comprises a top row of horizontally adjacent skid-blocks arranged at opposed angles relative to each corresponding horizontally adjacent skid-block.

In some embodiments, the method of providing a pipeline support comprises a plurality of skid-blocks arranged as a ground crotch support pile, the pipeline support comprises a plurality of skid-blocks arranged as a slider support pile, the pipeline support comprises a plurality of skid-blocks arranged in a box crotch support pile, the pipeline support comprises a plurality of skid-blocks arranged in a box support pile or combinations thereof in series along a portion of pipeline.

In some embodiments, the method of providing a pipeline support comprises a providing a skid-block support pile in series with a series of pipeline portions at interconnected. In some embodiments, the method of providing a pipeline support comprises a providing a skid-block support pile in series with a series of pipeline portions at interconnected, wherein the method of providing a pipeline support comprises a ground crotch support pile for an every 5^{th} support pile.

In some embodiments, the method of providing a pipeline support comprises using a slider support pile to adjust an elevation of the pipeline in increments by moving a top row of a plurality of skid-blocks via the receiving notches to a lower position relative to the vertically adjacent skid-blocks.

The design of the rubber or plastic skid-blocks provides a surface that will not damage the coating on the pipeline. This advantage saves time, labor, equipment and repair materials (i.e., jeep stick; sleeves; and two part epoxy cartridges). Moreover, the uniform interlocking design creates a stabile support platform resulting in a reduction or elimination shifting skid piles (i.e., crotches and/or sliders) which creates a safer work environment. In this aspect, the skid-blocks disclosed herein save time, personnel and equipment which would be needed to repair unsafe skid piles. Additional advantages include but are not limited to the rubber or plastic interlocking skid-blocks have a longer lifetime of use and they are recyclable. The handles allow for ease of maneuverability and in turn can be easily manually load onto trucks or skid sloops. The fluorescent orange or fluorescent yellow markings can be more easily observed or located in muddy conditions (i.e., ditches and/or bellholes), which saves on expenses and time by reducing or eliminating the issue of lost skids. The skid-blocks disclosed herein are designed for the pipelines used in the Oil and Gas Industry with the goal of reducing or eliminating pipeline coating damage and skid pile instability. The rubber interlocking skid-block design adds stability when building crotch skid piles and/or slider skid piles as the interlocking design creates a solid support structure. These advantages are intended to save time, labor, equipment and material costs associated with coating repair as well as the time, labor and equipment needed to re-build skid piles that have become unstable from expansion and/or contraction of the pipeline due to changes in ambient temperatures, improper construction and/or bumps from neighboring equipment.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A pipeline support, comprising: at least one skid-block, comprising a rectangular-shaped solid or hollow surface comprising
a top surface;
a bottom surface;
a left side surface and a right side surface; and a front side surface and a back side surface,
wherein the bottom surface comprises a plurality of receiving notches that are capable of interlocking with a width of the top surface of a vertically adjacent skid-block, and wherein the pipe support is capable of supporting a portion of a pipe in a stable position at a desired elevation on a portion of the top surface.

2. The pipeline support of claim 1, wherein the at least one skid-block is comprised of rubber, metal, plastic or a combination thereof.

3. The pipeline support of claim 1, wherein the top surface is comprised of rubber and/or plastic and is capable of reducing damage to a coating of a pipeline.

4. The pipeline support of claim 1, wherein the at least one skid-block comprises between about 2 to about 10 receiving notches.

5. The pipeline support of claim 1, wherein the at least one skid-block comprises between about 3 to about 4 receiving notches.

6. The pipeline support of claim 1, wherein the receiving notches are each comprised of a cavity that extends the width of the bottom surface and is capable of engaging with a vertically adjacent skid-block.

7. The pipeline support of claim 1, wherein the receiving notches are each comprised of a square or rectangular cavity that extends the width of the bottom surface and is capable of engaging with a vertically adjacent skid-block.

8. The pipeline support of claim 1, wherein the receiving notches are square or rectangular and are parallel and evenly spaced about a length of the bottom surface.

9. The pipeline support of claim 1, further comprising at least one interlocked pair of skid-blocks, wherein the interlocked skid-blocks are perpendicular relative to each other so as to prevent relative rotation thereof and to form an interlocked stack of vertically adjacent skid-blocks.

10. The pipeline support of claim 1, further comprising at least one interlocked pair of skid-blocks, wherein the interlocked skid-blocks are perpendicular relative to each other so as to prevent relative rotation thereof and to form an interlocked stack of vertically and horizontally adjacent skid-blocks.

11. The pipeline support of claim 1, further comprising a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a one or more rows of horizontally adjacent skid-blocks arranged at an angle relative to the corresponding vertically adjacent skid-blocks.

12. The pipeline support of claim 1, further comprising a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, and wherein the square or rectangular stack comprises a top row of horizontally adjacent skid-blocks arranged at an angle relative to the corresponding vertically adjacent skid-blocks.

13. The pipeline support of claim 1, further comprising a plurality of interlocked skid-blocks, wherein the interlocked skid-blocks are perpendicular relative to each other so as to prevent relative rotation thereof and to form an interlocked square or rectangular stack of vertically and horizontally adjacent skid-blocks, wherein the square or rectangular stack comprises a top row of horizontally adjacent skid-blocks arranged at opposed angles relative to each corresponding horizontally adjacent skid-block.

14. The pipeline support of claim 1, wherein the pipeline support comprises a plurality of skid-blocks arranged as a ground crotch support pile.

15. The pipeline support of claim 1, wherein the pipeline support comprises a plurality of skid-blocks arranged as a slider support pile.

16. The pipeline support of claim 1, wherein the pipeline support comprises a plurality of skid-blocks arranged in a box crotch support pile.

17. The pipeline support of claim 1, wherein the pipeline support comprises a plurality of skid-blocks arranged in a box support pile.

18. The pipeline support of claim 1, wherein the at least one skid-block has a thickness of between about 2 inches and 8 inches, a width of between about 2 inches and 12 inches and a length of between about 1 foot and 8 feet.

19. A method of providing a pipeline support, comprising:
a) providing a pipeline; and
b) arranging a plurality of skid-blocks to support the pipeline, wherein each skid-block comprises a rectangular-shaped solid or hollow surface comprising a top surface; a bottom surface; a left side surface and a right side surface; and a front side surface and a back side surface, wherein the bottom surface comprises a plurality of receiving notches that are capable of interlocking with a width of the top surface of a vertically adjacent skid-block, and wherein the pipe support is capable of supporting a portion of a pipe in a stable position at a desired elevation on a portion of the top surface.

20. The method of claim 19, wherein the pipeline support comprises a plurality of skid-blocks arranged as a ground crotch support pile, the pipeline support comprises a plurality of skid-blocks arranged as a slider support pile, the pipeline support comprises a plurality of skid-blocks arranged in a box crotch support pile, the pipeline support comprises a plurality of skid-blocks arranged in a box support pile or combinations thereof in series along a portion of pipeline.
